(19) United States
(12) Patent Application Publication
(10) Pub. No.: US 2004/0048735 A1
(43) Pub. Date: Mar. 11, 2004

(54) Rare earth or gallium additive composition, methods for preparing the same and use thereof as catalyst

(76) Inventor: Thomas Mathivet, Paris (FR)

Correspondence Address: Jean-Louis Seugnet, Rhodia Inc, Intellectual Property Department, 759 Prospect Plains Road CN 7500, Cranbury, NJ, 08512-7500, US

(21) Appl. No.: 10/398,044

(22) PCT Filed: Sep. 28, 2001
(86) PCT No.: PCT/FR01/03017

(30) Foreign Application Priority Data
Oct. 3, 2000 (FR) 00/12582

(51) Int. Cl. C01F 17/00; B01J 27/06; B01J 27/125; B01J 31/00; C07F 5/00

(52) U.S. Cl. 502/102; 502/224; 502/231; 502/103; 534/16

(57) ABSTRACT

The present invention concerns an addition compound of a carboxylic acid and a rare earth or gallium halide or a rare earth or gallium halogenocarboxylate of the same acid. This compound is obtained by a process in which a rare earth or gallium carboxylate is reacted with HX, X representing a halogen, in a solvent selected from alkanes, cycloalkanes and aromatic solvents and mixtures thereof, the reaction being carried out with an X/rare earth or gallium atomic ratio of less than 3 when preparing a halogenocarboxylate. The invention also concerns a second process for preparing an anhydrous addition compound of a rare earth or gallium halide and a nitrogen or oxygen donor compound in which an addition compound of a carboxylic acid and a rare earth halide of the type described above is prepared, and a nitrogen or oxygen donor is added to the medium obtained, the donor being selected from linear and cyclic aliphatic oxides, aliphatic glycol ethers, aliphatic ketones, aliphatic amides, aliphatic nitrites, aliphatic sulphoxides and hexamethylphosphotriamide.

The present invention relates to an addition compound of a carboxylic acid and a rare earth or gallium halide or halogenocarboxylate, to an anhydrous addition compound of a rare earth or gallium halide and a nitrogen or oxygen donor compound, to processes for their preparation and to their use as a catalyst.

Compounds based on rare earths and in particular on anhydrous halides of rare earths are very important compounds as regards their use as elements in catalysts for polymerising dienes such as butadiene. However, such compounds are difficult to prepare.

They can be prepared by reacting a rare earth carboxylate with a halogenated organometallic compound such as AlEt₂Cl or Al₂Et₃Cl₃ to produce the halogenated rare earth compound, for example the chloride. In a second step, that halogenated compound is reacted with a further organometallic compound such as Al(iBu)₃ to produce the catalytically active species. That preparation process is complex to carry out as organometallic aluminium complexes are pyrophoric and rare earth carboxylates can be in the form of very viscous solutions.

Further, it is very difficult to prepare an anhydrous rare earth chloride by simple thermal dehydration of a hydrated rare earth chloride such as the hexahydrated salt. The last molecule of water can react with the rare earth chloride to form a rare earth oxychloride in substantial proportions, for example more than 10%, and that oxychloride is usually undesirable in applications of the chloride. Other methods involve drying the hydrated rare earth chloride in the presence of ammonium chloride then sublimation of the latter, generally resulting in a product that is polluted by the drying agent.

Thus, there exists a need for a process providing access to such catalysts that is simpler to carry out, and for a rare earth or gallium halide type compound that is anhydrous and pure.

To this end, the invention concerns a first process that is a process for preparing an addition compound of a carboxylic acid and a rare earth or gallium halide or a rare earth or gallium halogenocarboxylate of the same acid, characterized in that HX, X representing a halogen, is reacted with a rare earth or gallium carboxylate in a solvent selected from alkanes, cycloalkanes, aromatic solvents and mixtures thereof, the reaction being carried out with an X/rare earth or gallium atomic ratio of less than 3 when preparing a halogenocarboxylate.

The invention also concerns, as a novel compound, an addition compound of a carboxylic acid and a rare earth or gallium halide or a rare earth or gallium halogenocarboxylate of the same acid.

The invention also concerns a second process, which is a process for preparing an anhydrous addition compound of a rare earth or gallium halide and a nitrogen or oxygen donor compound, characterized in that it comprises the following steps:

reacting a rare earth or gallium carboxylate with HX, X representing a halogen, in a solvent selected from alkanes, cycloalkanes, aromatic solvents and mixtures thereof, to form an addition compound of a carboxylic acid and a rare earth or gallium halide;

adding to the mixture obtained, a nitrogen or oxygen donor compound that is free of water and selected from linear and cyclic aliphatic ether-oxides, aliphatic glycol ethers, aliphatic ketones, aliphatic amides, aliphatic nitrites, aliphatic sulphoxides and hexamethylphosphotriamide, to precipitate an addition compound of a rare earth or gallium halide and said nitrogen or oxygen donor compound.

Finally, the invention concerns the anhydrous addition compound of a rare earth or gallium halide and a nitrogen or oxygen donor compound that can be obtained by the process described above.

The second process of the invention can produce a compound based on a rare earth or gallium halide that is anhydrous and of high purity. This process is simple, it does not necessitate the use of large excesses of reagents and avoids large amounts of effluent. Further, the carboxylic acid produced during the reaction and the solvent can readily be recycled. Finally, it is not necessary to use anhydrous nitrogen or oxygen donors or rare earth salts. It is also possible to use industrial solvents that contain water.

Further characteristics, details and advantages of the invention will become more apparent from the following description and the following non-limiting examples that are intended to illustrate the invention.

The term “rare earth” as used in the present description means elements from the group constituted by scandium, yttrium and elements from the periodic table with atomic numbers in the range 57 to 71 inclusive.

In the description X represents a halogen, i.e., fluorine, chlorine, bromine or iodine.

The first type of compound of the invention, i.e., the addition compound of a carboxylic acid and a rare earth or gallium halide or a rare earth or gallium halogenocarboxylate, will be described below.

The term “rare earth or gallium halogenocarboxylate” as used in the present description means a product that can be represented, for example, by the overall formula (1) MXₙA₃₋ₙ, without prejudicing the chemical bonds between the different elements.

The compound of the invention can, for example, be represented by formula (2):

MXₙA₃₋ₙ, xAH

In formulae (1) and (2), M represents a trivalent rare earth, or gallium, A represents the anionic portion of a carboxylic acid (AH represents the carboxylic acid), X represents a halogen as defined above, n satisfies the relationship 0<N<3 for (1) and 0≦n≦3 for (2), and x is a number that is more than 0 and is generally in the range 0 to 3 inclusive.

It should be noted here that the compound of the invention can be in the polymerised form, in which case it can be represented by the formula (3):

[MXₙA₃₋ₙ, xAH]ₚ

More particularly, M can be neodymium, praseodymium, lanthanum, gadolinium, samarium or cerium.

More particularly, X can be chlorine, bromine or iodine, still more particularly chlorine.

In particular, the carboxylic acid can be a linear or branched, saturated or unsaturated aliphatic, cycloaliphatic or aromatic acid. Preferably, it is an acid containing at least 6 carbon atoms, more particularly a C₆-C₃₂ acid, still more particularly C₆ to C₁₈.

More particularly again, the carboxylic acid can be selected from acids containing a ternary or quaternary carbon atom.

Examples of acids that can be cited are isopentanoic acid, hexanoic acid, 2-ethylhexanoic acid, 2-ethylbutyric acid, nonanoic acid, isononanoic acid, decanoic acid, octanoic acid, isooctanoic acid, neodecanoic acid, undecylenic acid, lauric acid, palmitic acid, stearic acid, oleic acid, linoleic acid and naphthenic acids.

Particular mention can be made of neodecanoic acid. This is a mixture of branched carboxylic acids generally containing about 10 carbon atoms and with an acid number of about 310 to about 325 mg KOH/g, sold by Shell under the trade name “Versatic 10” (generally known as versatic acid) or by Exxon under the trade name “Neodecanoic acid”.

The addition compound of the invention is generally in the form of a solution in a solvent. This solvent is selected from alkanes, cycloalkanes and aromatic solvents and mixtures thereof. Preferably, this solvent is selected from those that can form an azeotrope with water.

Examples of alkanes and cycloalkanes that can more particularly be mentioned are hexane, cyclohexane, pentane, cyclopentane, heptane and their derivatives and isomers such as methylpentane, methylcyclopentane or 2,3-dimethylbutane. Halogenated derivatives of those alkanes and cycloalkanes can also be mentioned, such as dichloromethane and chloroform. More particular examples of aromatic solvents that can be cited are benzene, ethylbenzene, toluene and xylene. Halogenated derivatives of aromatic solvents can also be used, such as chlorobenzene.

In the case of an addition compound of a carboxylic acid and a halogenocarboxylate, n in formula (2), which represents the value of the halogen/rare earth or gallium atomic ratio, is less than 3. More particularly, n can be in the range 0.1 (limit included) to 3, still more particularly in the range 1 to 2 (limits included).

The viscosity of the solution of the addition compound of the invention is low, generally close to that of the solvent. Thus, generally, the viscosity of the solutions is less than 100 cPs, preferably less than 50 cPs.

The water content of this solution is generally less than 1000 ppm, more particularly at most 500 ppm, still more particularly less than 200 ppm.

The solutions obtained are also very stable. Settling out of solid matter is not observed after a minimum period of three months.

The solutions can have a high concentration of rare earth or gallium, for example at least 10% by weight of rare earth or gallium carboxylate, this concentration possibly being 60%.

The invention also concerns a catalyst resulting from the reaction between an organometallic compound of an addition compound as described above.

This organometallic compound can be an aluminium, magnesium or lithium compound. Particular examples that can be cited are dialkylmagnesium compounds such as dibutylmagnesium. More particularly, the compound can be a compound with formula AlRR′R″, where R, R′ and R″ are identical or different and represent a hydrocarbon radical containing about 1 to 20 carbon atoms; one or two of R, R′ or R″ can be a hydrogen atom. Of these compounds, mention can be made of trialkylaluminium compounds, triarylaluminium compounds, dialkylaluminium hydrides, diarylaluminium hydrides, alkylarylaluminium hydrides, monoalkylaluminium dihydrides, monoarylaluminium dihydrides. Examples that can be mentioned are trimethylaluminium, triethylaluminium, tripropylaluminium, triisopropylaluminium, tri-n-butylaluminium, triisobutylaluminium, trioctylaluminium, tribenzylaluminium, trinaphthylaluminium, diisobutylaluminium hydride, dihexylaluminium hydride, methylaluminium dihydride, ethylaluminium dihydride, and butylaluminium dihydride.

The organometallic compound and the addition compound are reacted together in a known manner, in particular within a wide temperature range of from about 0° C. to about 150° C., preferably about 25° C. to 80° C. The reaction is carried out with stirring, for example over a period of a few minutes to about 2 hours. The product of the reaction is recovered by distillation under reduced pressure or by filtering or decanting, and it is optionally washed with a dry hydrocarbon such as n-heptane.

The catalyst can be used to polymerise or copolymerise unsaturated compounds, in particular dienes.

Unsaturated compounds that can be cited include ethylene, 1,3-butadiene, isoprene, trans-1,3-pentadiene, trans-1,3-hexadiene, trans 2-methyl-1,3-pentadiene, trans-3-methyl-1,3-pentadiene and 2,3-dimethyl-1,3-butadiene.

More particularly, the catalyst obtained with an organomagnesium or organolithium compound can be used for stereospecific trans polymerisation of butadiene. The catalyst obtained with an organoaluminium compound can more particularly be used for stereospecific cis butadiene polymerisation.

The process for preparing the first addition compound of the invention will now be described.

As indicated above, the addition compound of the invention is obtained by reacting a rare earth or gallium carboxylate with HX in a solvent selected from alkanes, cycloalkanes, aromatic solvents and mixtures thereof, this solvent being as defined above.

The rare earth carboxylates used as starting products are those corresponding to the carboxylic acids defined above. Preferably, carboxylates that are soluble in the solvent cited above are used. Particular examples of starting carboxylates that can be used in the process of the invention that can be cited are liquid compositions of rare earth carboxylates described in International patent application WO-A-99/54335.

Preferably, a rare earth or gallium carboxylate that is initially anhydrous is used. The term “anhydrous carboxylate” means a carboxylate with a water content of at most 500 ppm, preferably at most 200 ppm, more preferably at most 100 ppm.

HX is preferably used in the gaseous form; in this case, the reaction taking place in the process is a liquid-gas reaction. The reaction can be carried out at low HX pressures.

HX can also be used in solution in an anhydrous organic solvent. Solvents for HX that can be mentioned are those given above, i.e., alkanes and cycloalkanes, aromatic solvents, and their halogenated derivatives.

The reaction with HX is normally carried out at ambient temperature (10° C. to 25° C., for example).

The reaction with HX is carried out at stoichiometric ratios or close thereto. Thus, it is possible to operate with a slight excess of HX with respect to the stoichiometric quantities, for example with a rare earth or gallium/HX mole ratio of 1/3.5. When preparing an addition compound of a carboxylic acid and a halogenocarboxylate, the reaction is carried out using quantities of reactants such that the X/rare earth or gallium atomic ratio is less than 3.

This reaction produces a compound that remains in solution in the solvent for the reaction medium and which is an addition compound of a rare earth or gallium halide and the acid corresponding to the rare earth or gallium salt, i.e., a carboxylic acid as defined above. The reaction can be written as follows:

MA₃+nHX→MA₃₋ₙXₙ, xAH+(n−x)AH

or:

pMA₃+pnHX→[MA₃₋ₙXₙ, xAH]ₚ+p(n−x)AH

if, as indicated above, the compound can be obtained in the polymerised form.

M, X, N, x and A have the same meanings as those given above.

The invention also concerns a second process, which is a process for preparing an anhydrous addition compound of a neodymium or cerium halide and a nitrogen or oxygen donor compound and which will now be described. This process uses the addition compound of a carboxylic acid and a rare earth or gallium halide described above. For this reason, this process comprises a first step, which consists of preparing this addition compound and in which a rare earth or gallium carboxylate is reacted with HX, X representing a halogen, in a solvent selected from alkanes, cycloalkanes and aromatic solvents and mixtures thereof. The foregoing description regarding this step is also applicable in this instance.

This second process also comprises a second step. This second step consists of adding a nitrogen or oxygen donor compound to the medium obtained at the end of the first step. It should be noted here that it is not necessary for this donor compound to be free of water. However, it is possible to use an anhydrous donor compound, “anhydrous” as used here meaning a product with a water content of at most 100 ppm, more particularly at most 50 ppm, and still more particularly at most 20 ppm.

Firstly, this compound can be selected from linear and cyclic aliphatic ether-oxides. For the linear ether-oxides, those containing more than 4 carbon atoms are generally used. More particular cyclic compounds that can be cited are tetrahydrofuran (THF), 1,4-dioxane, and tetrahydropyran.

The compound can also be selected from aliphatic glycol ethers. Examples that can be mentioned are 1,2-methoxyethane, 1,2-diethoxyethane, and 2-methoxyethylether (diglyme).

The compound can also be selected from aliphatic ketones. More particularly, saturated aliphatic ketones can be used such as acetone, methylethylketone or methylisobutylketone.

Aliphatic amides can also constitute compounds for use in the context of the present invention, for example dimethylformamide.

It is also possible to use aliphatic nitrites such as acetonitrile.

The compound can also be selected from aliphatic sulphoxides such as dimethylsulphoxide.

Finally, hexamethylphosphotriamide can be cited as a suitable compound.

The nitrogen or oxygen donor compound is preferably added in an inert gas, for example argon, and at ambient temperature. In particular, the quantity of this donor compound can be in the range 10 to 50, which quantity is expressed as the mole ratio of the nitrogen or oxygen donor compound/addition compound of rare earth or gallium halide and acid (MX₃, xAH, for example).

Adding the nitrogen or oxygen donor compound causes precipitation of an addition compound of the rare earth or gallium halide and said nitrogen or oxygen donor compound. As an example in the case of THF, the reaction can be written in the following manner:

MX₃, xAH+THF→MX₃, yTHF+xAH

or:

[MX₃, xAH]ₚ+pTHF→[MX₃, yTHF]ₚ+pxAH

in the case of polymerised forms,

M, X, x and A having the meanings defined above and y being a number that is generally in the range 1 to 6.

The precipitate is separated from the reaction medium by any suitable means. It can be washed with a solvent of the same type as that used for the reaction medium. It can also be vacuum dried at ambient temperature, for example.

The invention also concerns a process that is more specific to the preparation of an anhydrous compound based on a neodymium or cerium halide. This process is of the same type as that described above, but ethanol is used in the second step. The above description pertaining to the general process, in particular as regards the second step, is also applicable to this specific process.

The invention also concerns, as a novel product, a compound of a second type, i.e., the addition compound of a rare earth or gallium halide and a nitrogen or oxygen donor compound that can be obtained by the second process of the invention just described. This implies that the above description regarding the process is also applicable to the definition of the product.

This addition compound has a water content of less than 5500 ppm, in particular less than 2000 ppm. Preferably, this water content is less than 1000 ppm, still more preferably less than 500 ppm. This second addition compound also has a rare earth or gallium oxyhalide content of at most 1000 ppm. In general, the compound contains no acid AH as defined above.

This second addition compound can be constituted by particles with a mean size of 1 μm to 100 μm, this size being measured by a laser technique using a CILAS type apparatus.

In this second compound, the rare earth can more particularly be neodymium, praseodymium, lanthanum, gadolinium, samarium or cerium, and the halide can more particularly be chlorine.

The second anhydrous compound of the invention can be used as an element of a catalyst for polymerising or copolymerising unsaturated compounds, in particular dienes. More particular unsaturated compounds that can be mentioned are ethylene, propylene, butadiene and styrene. It can also be used as an element in a catalyst for acylating aromatic compounds. Thus, the invention also concerns catalysts of the type defined above, comprising the anhydrous compound of the invention. When polymerising or copolymerising unsaturated compounds, the catalysts generally also contain organic aluminium compounds.

This second compound can also be used as a starting product for preparing rare earth organometallic complexes, such as alcoholates, amides or lanthanocenes.

Examples will now be given.

### EXAMPLE 1

This example concerns a compound of the second type of the invention, i.e., an anhydrous addition compound of a neodymium versatate and THF.

71.53 g of a solution of neodymium versatate (Nd=5.2% by weight, i.e., 0.0315 mole of Nd) in hexane was placed in a 250 ml two-necked flask provided with an argon inlet. A Dean-Stark apparatus was fitted to the flask and distillation was carried out until the water content was 15 ppm (measured using the Karl Fisher technique).

Under helium, a reflux cooler connected to an oil bubbler was fitted to the flask containing the anhydrous solution. A bubbler tube provided with a porosity 1 frit was fitted in an airtight manner to the second neck of the flask. The assembly was purged with helium for 10 minutes, then with hydrogen chloride for 5 minutes. Using moderate stirring and at ambient temperature, HCl was bubbled into the solution at a flow rate of 50 ml/min over 1 hour at a pressure of 1 bar (volume of HCl=2.5 l, i.e., 0.106 moles).

100 ml of anhydrous THF was then added under argon using a syringe. A precipitate formed instantaneously and was re-dissolved in the next 5 minutes. 10 minutes later, the solution produced a blue solid. This solid was filtered under argon through a size 4 frit. The precipitate was washed with 40 ml of anhydrous hexane. 15.3 g of versatic acid was recovered after evaporating the filtrate to dryness. The precipitate was dried under vacuum to constant weight. 10.18 g of solid was obtained. The product was placed in a glovebox.

The water content (Karl Fisher) of this solid was 210 ppm, the neodymium content (measured by complexometry) was 36.3%, the chlorine content (measured by argentometry) was 27.0% and that of oxychloride was NdOCl (measured by acid consumption) was less than 1000 ppm.

Proton NMR analysis showed the presence of THF and the absence of versatic acid in the solid. Microanalysis produced the following results: C=23.0%, H=4.0% and N was less than 1000 ppm. The formula for this product was NdCl₃. The yield was 96%.

### EXAMPLE 2

This example concerns a compound of the second type of the invention, i.e., an anhydrous addition compound of a lanthanum neodecanoate and THF.

83.02 g of a solution of lanthanum neodecanoate (La=4.45% by weight, 0.0266 mole of La) in hexane was placed in a 250 ml two-necked flask provided with an argon inlet. A Dean-Stark apparatus was fitted to the flask and distillation was carried out until the water content was 30 ppm (measured using the Karl Fisher technique).

Under helium, a reflux cooler connected to an oil bubbler was fitted to the flask containing the anhydrous solution. A bubbler tube provided with a porosity 1 frit was fitted in an airtight manner to the second neck of the flask. The assembly was purged with helium for 10 minutes, then with hydrogen chloride for 5 minutes. Using moderate stirring and at ambient temperature, HCl was bubbled into the solution at a flow rate of 50 ml/min over 63 minutes at a pressure of 1 bar (volume of HCl=2.7 l, i.e., 0.114 moles).

30 ml of anhydrous THF was then added under argon using a syringe. A white precipitate formed instantaneously. This solid was filtered under argon through a size 4 frit. The precipitate was washed with 40 ml of anhydrous hexane. The precipitate was dried under vacuum to constant weight. The product was placed in a glovebox.

The water content (Karl Fisher) the lanthanum content (complexometry), the chlorine content (measured by argentometry) and oxychloride content (acid consumption) of the solid were determined. The following values were obtained: water=4140 ppm, La=38.8%, Cl=29.9% and LaOCl was less than 1000 ppm. 6.70 g of solid was isolated. Proton NMR analysis showed the presence of THF and the absence of neodecanoic acid in the solid. The formula for this product was LaCl₃, 1.5 THF. The yield was 71%.

### EXAMPLE 3

This example concerns a compound of the second type of the invention, i.e., an anhydrous addition compound of a cerium neodecanoate and THF.

69.77 g of a solution of cerium (III) neodecanoate (Ce=4.95% by weight, 0.0246 mole of Ce) in hexane was placed in a 250 ml two-necked flask provided with an argon inlet.

A Dean-Stark apparatus was fitted to the flask and distillation was carried out until the water content was 45 ppm (measured using the Karl Fisher technique).

Under helium, a reflux cooler connected to an oil bubbler was fitted to the flask containing the anhydrous solution. A bubbler tube provided with a porosity 1 frit was fitted in an airtight manner to the second neck of the flask. The assembly was purged with helium for 10 minutes, then with hydrogen chloride for 5 minutes. Using moderate stirring and at ambient temperature, HCl was bubbled into the solution at a flow rate of 50 ml/min over 48 minutes at a pressure of 1 bar (volume of HCl=2.0 l, i.e., 0.0861 moles).

20 ml of anhydrous THF was then added under argon using a syringe. A white precipitate formed instantaneously. This solid was filtered under argon through a size 4 frit. The precipitate was washed with 40 ml of anhydrous hexane. The precipitate was dried under vacuum to constant weight. The product was placed in a glovebox.

The water content (Karl Fisher) the cerium content (complexometry), the chlorine content (measured by argentometry) and oxychloride content (acid consumption) of the solid were determined. The following values were obtained: water=5300 ppm, Ce=41.9%, Cl=32.45% and CeOCl was less than 1000 ppm. 7.53 g of solid was isolated. Proton NMR analysis showed the presence of THF and the absence of neodecanoic acid in the solid. The formula for this product was CeCl₃, 1.2 THF. The yield was 92%.

### EXAMPLE 4

This example concerns a compound of the second type of the invention, i.e., an anhydrous addition compound of a samarium neodecanoate and THF.

85.09 g of a solution of samarium neodecanoate (Sm=8.1% by weight, 0.0458 mole of Sm, water=60 ppm) in cyclohexane was placed in a 250 ml two-necked flask (provided with an argon inlet).

Under helium, a reflux cooler connected to an oil bubbler was fitted to the flask containing the solution. A bubbler tube provided with a porosity 1 frit was fitted in an airtight manner to the second neck of the flask. The assembly was purged with helium for 10 minutes, then with hydrogen chloride for 10 minutes. Using moderate stirring and at ambient temperature, HCl was bubbled into the solution at a flow rate of 50 ml/min over 65 minutes at a pressure of 1 bar (volume of HCl=3.25 l, i.e., 0.137 moles).

37 ml of industrial THF (0.457 mole, water=1200 ppm) was then added under argon using a syringe. 3 minutes after adding the THF, a precipitate formed and the viscosity of the solution increased. After stirring for 5 minutes, the solution became fluid again. The suspension was stirred for an additional 30 minutes and the solid was filtered under argon through a size 4 frit. The precipitate was washed with 2×40 ml of industrial hexane (water=23 ppm). The solid was dried under vacuum to constant weight. The product was placed in a glovebox.

The water content (Karl Fisher) the samarium content (complexometry), the chlorine content (measured by argentometry) and oxychloride content (acid consumption) of the solid were determined. The following values were obtained: water=350 ppm, Sm=37.05%, Cl=26.0% and SmOCl<<1000 ppm. 15.18 g of solid was isolated. The formula for this product was SmCl₃(THF)₂. The yield was 83%.

### EXAMPLE 5

This example concerns a compound of the second type of the invention, i.e., an anhydrous addition compound of a neodymium neodecanoate and THF.

94.8 g of a solution of neodymium neodecanoate (Nd=9.7% by weight, 0.0634 mole of Nd, water=180 ppm) in hexane was placed in a 250 ml two-necked flask (provided with an argon inlet).

Under helium, a reflux cooler connected to an oil bubbler was fitted to the flask containing the anhydrous solution. A bubbler tube provided with a porosity 1 frit was fitted in an airtight manner to the second neck of the flask. The assembly was purged with helium for 10 minutes, then with hydrogen chloride for 5 minutes. Using moderate stirring and at ambient temperature, HCl was bubbled into the solution at a flow rate of 50 ml/min over 105 minutes at a pressure of 1 bar (volume of HCl=5.25 l, i.e., 0.222 moles).

52 ml of industrial THF (0.634 mole, water=1200 ppm) was then added under argon using a syringe. A purple precipitate formed instantaneously and the viscosity of the solution increased. After stirring for 5 minutes, the solution became fluid again. The suspension was stirred for a further 30 minutes and the blue solid was filtered under argon through a size 4 frit. The precipitate was washed with 2×40 ml of industrial hexane (water=23 ppm). The precipitate was dried under vacuum to constant weight. The product was placed in a glovebox.

The water content (Karl Fisher) the neodymium content (complexometry), the chlorine content (measured by argentometry) and oxychloride content (acid consumption) of the solid were determined. The following values were obtained: water=170 ppm, Nd=36.45%, Cl=26.5% and NdOCl<<1000 ppm. 21.34 g of solid was isolated. The formula for this product was NdCl₃ (THF)₂. The yield was 85%. It was in the form of particles with a size in the range 0.4 μm to 100 μm (CILAS laser) with a bi-distributed population at 10 μm and at 40 μm.

### EXAMPLE 6

This example concerns a compound of the second type of the invention, i.e., an anhydrous addition compound of a neodymium neodecanoate and THF.

88.56 g of a solution of neodymium neodecanoate (Nd=8.9% by weight, 0.0546 mole of Nd, water=270 ppm) in hexane was placed in a 250 ml two-necked flask (provided with an argon inlet).

Under helium, a reflux cooler connected to an oil bubbler was fitted to the flask containing the anhydrous solution. A bubbler tube provided with a porosity 1 frit was fitted in an airtight manner to the second neck of the flask. The assembly was purged with helium for 10 minutes, then with hydrogen chloride for 5 minutes. Using moderate stirring and at ambient temperature, HCl was bubbled into the solution at a flow rate of 50 ml/min over 77 minutes at a pressure of 1 bar (volume of HCl=3.87 l, i.e., 0.164 moles).

45 ml of industrial THF (0.546 mole, water=970 ppm) was then added under argon using a syringe. A purple precipitate formed instantaneously and rapidly re-dissolved. After stirring for 5 minutes, the product re-crystallised in the form of a fine powder. The suspension was stirred for a further 30 minutes and the blue solid was filtered under argon through a size 4 frit. The precipitate was washed with 2×40 ml of industrial hexane (water=23 ppm). The solid was dried under vacuum to constant weight. The product was placed in a glovebox.

The water content (Karl Fisher) the neodymium content (complexometry), the chlorine content (measured by argentometry) and oxychloride content (acid consumption) of the solid were determined. The following values were obtained: water=150 ppm, Nd=36.2%, Cl=26.6% and NdOCl<<1000 ppm. 18.48 g of solid was isolated. The formula for this product was NdCl₃ (THF)₂. The yield was 85%.

This example shows that the process of the invention can be carried out with industrial THF containing water.

### EXAMPLE 7

This example concerns a compound of the second type of the invention, i.e., an anhydrous addition compound of a neodymium neodecanoate and dioxane.

187.65 g of a solution of neodymium neodecanoate (Nd=4.65% by weight, 0.060 mole of Nd, water=110 ppm) in hexane was placed in a 500 ml two-necked flask (provided with an argon inlet).

Under helium, a reflux cooler connected to an oil bubbler was fitted to the flask containing the anhydrous solution. A bubbler tube provided with a porosity 1 frit was fitted in an airtight manner to the second neck of the flask. The gas line was purged with helium for 10 minutes, then with hydrogen chloride for 5 minutes. Using moderate stirring and at ambient temperature, HCl was bubbled into the solution at a flow rate of 50 ml/min over 104 minutes at a pressure of 1 bar (volume of HCl=5.20 l, i.e., 0.220 moles).

52 ml of anhydrous dioxane (0.600 mole, water=15 ppm) was then added under argon using a syringe. A fairly thick precipitate formed instantaneously. After stirring for 2 hours 30 minutes, the solution was much more fluid and the solid was filtered under argon through a size 4 frit. The precipitate was washed with 60 ml of industrial hexane (water=23 ppm). The solid was dried under vacuum to constant weight. The product was placed in a glovebox.

The water content (Karl Fisher) the neodymium content (complexometry), the chlorine content (measured by argentometry) and oxychloride content (acid consumption) of the solid were determined. The following values were obtained: water=1980 ppm, Nd=30.3%, Cl=23.2% and NdOCl<<1000 ppm. 24.71 g of solid was isolated. The formula for this compound was NdCl₃ (dioxane)_{2.5}. The yield was 87%.

### EXAMPLE 8

This example concerns a compound of the second type of the invention, i.e., an anhydrous addition compound of a lanthanum neodecanoate and THF.

1.321 kg of a solution of lanthanum neodecanoate (La=4.47% by weight, 0.425 mole of La, water=38 ppm) in hexane was placed in a 4 litre two-necked flask (provided with an argon inlet).

Under helium, a reflux cooler connected to an oil bubbler was fitted to the flask containing the anhydrous solution. A bubbler tube provided with a porosity 1 frit was fitted in an airtight manner to the second neck of the flask. The gas line was purged with helium for 10 minutes, then with hydrogen chloride for 5 minutes. Using moderate stirring and at ambient temperature, HCl was bubbled into the solution at a flow rate of 200 ml/min over 198 minutes at a pressure of 1 bar (volume of HCl=39.63 l, i.e., 1.657 moles).

343 ml of anhydrous THF (water=9 ppm) was added under argon. A pink gel formed instantaneously. After stirring, this gel was transformed into a white suspension. Stirring was continued for 3 hours. This solid was filtered under argon through a size 4 frit. The precipitate was washed with 2×400 ml of industrial hexane (water=23 ppm). The solid was dried under vacuum to constant weight. The product was placed in a glovebox.

The water content (Karl Fisher) the lanthanum content (complexometry), the chlorine content (measured by argentometry) and oxychloride content (acid consumption) of the solid were determined. The following values were obtained: water=1900 ppm, La=41.4%, Cl=31.9% and LaOCl<<1000 ppm. 130.8 g of solid was isolated. The formula for this product was LaCl₃ (THF)_{1.2}. The yield was 93%.

This example shows that the process of the invention can be carried out with industrial hexane containing water.

### EXAMPLE 9

This example concerns a compound of the first type of the invention, i.e., an addition compound of a neodymium chloroversatate.

126.03 g of a solution of neodymium versatate (Nd=4.45% by weight, 0.0389 mole of Nd) in hexane was placed in a 250 ml two-necked flask provided with an argon inlet. A Dean-Stark apparatus was fitted to the flask and distillation was carried out until the water content was 15 ppm (measured using the Karl Fisher technique).

Under helium, a reflux cooler connected to an oil bubbler was fitted to the flask containing the anhydrous solution. A bubbler tube provided with a porosity 1 frit was fitted in an is airtight manner to the second neck of the flask. The assembly was purged with helium for 10 minutes, then with hydrogen chloride for 5 minutes. Using moderate stirring and at ambient temperature, HCl was bubbled into the solution at a flow rate of 50 ml/min over 18 minutes 30 seconds at a pressure of 1 bar (volume of HCl=0.925 l, i.e., 0.039 moles). 122.0 g of a purple solution was obtained.

The water content (Karl Fisher) the neodymium content (complexometry), the chlorine content (measured by argentometry) of the solution were determined. The following values were obtained: water=175 ppm, Nd=4.60%, Cl=1.06%. The formula for this product, NdV₂Cl, xVH(x≦1), was in agreement with elemental analysis. The yield, using HCl consumption, was 93%.

### EXAMPLE 10

This example concerns a compound of the first type of the invention, i.e., an addition compound of a neodymium chloroversatate.

71.67 g of a solution of neodymium versatate (Nd=4.55% by weight, 0.0226 mole of Nd) in hexane was placed in a 250 ml two-necked flask provided with an argon inlet. A Dean-Stark apparatus was fitted to the flask and distillation was carried out until the water content was 15 ppm (measured using the Karl Fisher technique).

The procedure of Example 9 was then followed, and by bubbling HCl into the solution at a flow rate of 50 ml/min for 21 minutes 30 seconds at a pressure of 1 bar (volume of HCl=1.07 l, i.e., 0.045 moles). 68.7 g of a pale purple solution was obtained.

The water content, the neodymium content and the chlorine content (argentometry) of the solution were determined using the methods described above. The following values were obtained: water=121 ppm, Nd=4.75%, Cl=2.35%. The formula for this product, NdV₂Cl, xVH(x≦2), was in agreement with elemental analysis. The yield, using HCl consumption, was 100%.

### EXAMPLE 11

This example concerns a compound of the first type of the invention, i.e., an addition compound of a neodymium chloroversatate.

79.05 g of a solution of neodymium versatate (Nd=4.55% by weight, 0.0249 mole of Nd) in hexane was placed in a 250 ml two-necked flask (provided with an argon inlet). A Dean-Stark apparatus was fitted to the flask and distillation was carried out until the water content was 15 ppm (measured using the Karl Fisher technique).

The procedure of Example 9 was then followed, and by bubbling HCl into the solution at a flow rate of 50 ml/min for 17 minutes at a pressure of 1 bar (volume of HCl=0.850 l, i.e., 0.036 moles). 77.4 g of a pale purple solution was obtained.

The water content (Karl Fischer), the neodymium content (complexometry) and the chlorine content (argentometry) of the solution were determined using the methods described above. The following values were obtained: water=136 ppm, Nd=4.65%, Cl=1.76%. The formula for this product, Nd₂V₃Cl₃, xVH(x≦3), was in agreement with elemental analysis. The yield, using HCl consumption, was 100%.

### EXAMPLE 12

This example concerns the use of a compound of the first type of the invention as a catalyst.

250 ml of anhydrous hexane was placed in a jacketed 500 ml glass Büchi autoclave that had been dried and inerted under argon. 26.0 g of butadiene was then introduced by double weighing. The temperature of the mixture was then raised to 70° C. 2.1 ml of diisobutylaluminium hydride solution (1.0 M in hexane) then 220 μl of a solution as described in Example 11 were then added. Polymerisation was carried out for 134 minutes.

The polymer was precipitated in about 500 ml of methanol containing about 0.5 g of 2,6-ditertiobutyl-4-methylphenol (BHT). The weight of the polybutadiene isolated was 12.97 g (yield=50%), with a degree of 1,4-cis binding of 91% (1,4-trans=8% and vinyl=1%), with a molecular weight Mw=236000 (g/mol) and Mw/Mn=4.2.

### EXAMPLE 13

This example concerns the use of a compound of the first type of the invention as a catalyst.

250 ml of anhydrous hexane was placed in a jacketed 500 ml glass Büchi autoclave that had been dried and inerted under argon. 26.0 g of butadiene was then introduced by double weighing. The temperature of the mixture was then raised to 70° C. 2.1 ml of diisobutylaluminium hydride solution (1.0 M in hexane) then 215 μl of a solution as described in Example 10 were then added. It was highly exothermic. Polymerisation was carried out for 128 minutes.

The polymer was precipitated in about 500 ml of methanol containing about 0.5 g of 2,6-ditertiobutyl-4-methylphenol (BHT). The weight of the polybutadiene isolated was 24.1 g (yield=93%), with a degree of 1,4-cis binding of 94% (1,4-trans=5% and vinyl=1%), with a molecular weight Mw=529000 (g/mol) and Mw/Mn=6.3.

1. An addition compound of a carboxylic acid and a rare earth or gallium halide or a rare earth or gallium halogenocarboxylate of the same acid.

2. A compound according to claim 1, characterized in that the rare earth is neodymium, praseodymium, lanthanum, gadolinium, samarium or cerium.

3. A compound according to claim 1 or claim 2, characterized in that the halogen is chlorine.

4. A compound according to any one of the preceding claims, characterized in that the carboxylic acid is an acid containing at least 6 carbon atoms, more particularly between 6 and 32 carbon atoms.

5. A compound according to any one of the preceding claims, characterized in that it is in the form of a solution in a solvent selected from alkanes, cycloalkanes, aromatic solvents and mixtures thereof.

6. An addition compound of a carboxylic acid and a halogenocarboxylate according to any one of the preceding claims, characterized in that it has a halogen/rare earth or gallium atomic ratio of less than 3.

7. A compound according to claim 6, characterized in that it is in the form of a solution with a water content that is less than 1000 ppm, more particularly at most 500 ppm.

8. A process for preparing a compound according to any one of the preceding claims, characterized in that HX, X representing a halogen, is reacted with a rare earth or gallium carboxylate in a solvent selected from alkanes, cycloalkanes, aromatic solvents and mixtures thereof, the reaction being carried out with an X/rare earth or gallium atomic ratio of less than 3 in the case of preparation of a halogenocarboxylate.

9. A process according to claim 8, characterized in that the HX is reacted in the gaseous form.

10. A process according to claim 8 or claim 9, characterized in that the solvent is selected from solvents forming an azeotrope with water.

11. A process for preparing an anhydrous addition compound of a rare earth or gallium halide and a nitrogen or oxygen donor compound, characterized in that it comprises the following steps:
reacting a rare earth or gallium carboxylate with HX, X representing a halogen, in a solvent selected from alkanes, cycloalkanes, aromatic solvents and mixtures thereof, to form an addition compound of a carboxylic acid and a rare earth or gallium halide;
adding a nitrogen or oxygen donor compound to the mixture obtained, selected from linear and cyclic aliphatic ether-oxides, aliphatic glycol ethers, aliphatic ketones, aliphatic amides, aliphatic nitrites, aliphatic sulphoxides and hexamethylphosphotriamide, to precipitate an addition compound of a rare earth or gallium halide and said nitrogen or oxygen donor compound.

12. A process for preparing an anhydrous addition compound of a neodymium or cerium halide and a nitrogen or oxygen donor compound, characterized in that it comprises the following steps:
reacting a neodymium or cerium carboxylate with HX, X representing a halogen, in a solvent selected from alkanes, cycloalkanes, aromatic solvents and mixtures thereof, to form an addition compound of a carboxylic acid and a neodymium or cerium halide;
adding ethanol to the medium obtained to precipitate an addition compound of neodymium or cerium halide and ethanol.

13. A process according, to claim 11 or claim 12, characterized in that a rare earth or gallium chloride is prepared, X representing chlorine.

14. A process according to any one of claims 11 to 13, characterized in that the rare earth is neodymium, praseodymium, lanthanum, gadolinium, samarium or cerium.

15. A process according to any one of claims 11 to 14, characterized in that the solvent is selected from solvents forming an azeotrope with water.

16. A process according to any one of claims 11 to 15, characterized in that the solvent is selected from hexane, cyclohexane, toluene, benzene and xylene.

17. A process according to any one of claims 11 to 16, characterized in that the nitrogen or oxygen donor compound is selected from tetrahydrofuran, acetone, 1,4-dioxane and acetonitrile.

18. An anhydrous addition compound of a rare earth or gallium halide and a nitrogen or oxygen donor compound selected from linear and cyclic aliphatic ether-oxides, aliphatic glycol ethers, aliphatic ketones, aliphatic amides, aliphatic nitrites, aliphatic sulphoxides and hexamethylphosphotriamide, characterized in that it can be obtained by a process that comprises the following steps:
reacting a rare earth or gallium carboxylate with HX, X representing a halogen, in a solvent selected from alkanes, cycloalkanes, aromatic solvents and mixtures thereof, to form an addition compound of a carboxylic acid and a rare earth or gallium halide;
adding a nitrogen or oxygen donor compound to the mixture obtained, selected from linear and cyclic aliphatic ether-oxides, aliphatic glycol ethers, aliphatic ketones, aliphatic amides, aliphatic nitrites, aliphatic sulphoxides and hexamethylphosphotriamide, to precipitate an addition compound of a rare earth or gallium halide and said nitrogen or oxygen donor compound.

19. A compound according to claim 18, characterized in that the rare earth is neodymium, praseodymium, lanthanum, gadolinium, samarium or cerium.

20. An addition compound of a neodymium or cerium halide and ethanol, characterized in that it can be obtained by a process comprising the following steps:
reacting a neodymium or cerium carboxylate with HX, X representing a halogen, in a solvent selected from alkanes, cycloalkanes, aromatic solvents and mixtures thereof;
adding ethanol to the medium obtained to precipitate an addition compound of neodymium or cerium halide and ethanol.

21. A compound according to any one of claims 18 to 20, characterized in that the halogen is chlorine.

22. A composition according to any one of claims 18 to 21, characterized in that the nitrogen or oxygen donor compound is selected from tetrahydrofuran, acetone, 1,4-dioxane and acetonitrile.

23. A compound according to any one of claims 18 to 22, characterized in that it has formula LaCl₃, 1.5THF, CeCl₃, 1.2 THF or NdCl₃ (dioxane)_{2.5}.

24. A compound according to any one of claims 18 to 21, characterized in that it has a water content of less than 5500 ppm, preferably less than 1000 ppm, and a rare earth or gallium oxyhalide content of at most 1000 ppm.

25. A compound according to claim 24, characterized in that it has a water content of less than 500 ppm.

26. A catalyst for polymerising or copolymerising unsaturated compounds, in particular dienes, characterized in that it comprises a compound according to any one of claims 18 to 25.

27. A catalyst for acylating aromatic compounds, characterized in that it comprises a compound according to any one of claims 18 to 25.

28. A catalyst, characterized in that it results from the reaction of an addition compound of a carboxylic acid and a halogenocarboxylate according to any one of claims 1 to 7 with an organometallic compound.

29. A catalyst according to claim 28, characterized in that the metallic element of the organometallic compound is aluminium, magnesium or lithium.

30. A process for polymerising unsaturated compounds, characterized in that a catalyst according to any one of claims 26 to 29 is used.
